(19) United States
(12) Patent Application Publication
(10) Pub. No.: US 2010/0071674 A1
(43) Pub. Date: Mar. 25, 2010

(54) METHOD FOR OPERATING AN INTERNAL COMBUSTION ENGINE

(75) Inventors: FRANK RABE, Hiddenhausen (DE); Björn RICHTER, Paderborn (DE); Max NIESSE, Paderborn (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Benteler Automobiltechnik GmbH, Paderborn (DE)

(21) Appl. No.: 12/567,151

(22) Filed: Sep. 25, 2009

(30) Foreign Application Priority Data
Sep. 25, 2008 (DE) 10 2008 048 973.5

(51) Int. Cl. F02M 25/07; F01N 1/00; F02M 25/06

(52) U.S. Cl. 123/568.11; 60/324; 60/278

(57) ABSTRACT

In a method of operating an internal combustion engine which has a fresh-air line, an exhaust-gas line, and an exhaust gas recirculation system, an exhaust gas flow is fed from the exhaust gas recirculation line of the exhaust gas recirculation system to the fresh-air line. The exhaust gas flow is hereby divided by a gas flow divider during flow from the exhaust gas recirculation line to the fresh-air line through actuation of a control element such that a first flow portion flows back to the exhaust gas recirculation line and a second flow portion flows to a continuing section of the exhaust-gas line. The exhaust gas recirculation system with the gas flow divider is operated substantially in the absence of a back pressure.

### CROSS-REFERENCES TO RELATED APPLICATIONS

This application claims the priority of German Patent Application, Serial No. 10 2008 048 973.5, filed Sep. 25, 2008, pursuant to 35 U.S.C. 119(a)-(d), the content of which is incorporated herein by reference in its entirety as if fully set forth herein.

### BACKGROUND OF THE INVENTION

The present invention relates to a method of operating an internal combustion engine.

The following discussion of related art is provided to assist the reader in understanding the advantages of the invention, and is not to be construed as an admission that this related art is prior art to this invention.

Examples of an internal combustion engine include an Otto engine or a Diesel engine in which a portion of exhaust gas is recirculated to a fresh-air line via an exhaust gas recirculation line to thereby reduce oxygen concentration and thus to cause a reduction in the nitrogen oxide emission. Internal combustion engines may be charged, e.g. with a turbocharger having a compressor arranged in the fresh-air line and a turbine arranged in the exhaust-gas line. Depending on the location where the exhaust gas recirculation line branches off from the exhaust-gas line, reference is made to a low-pressure exhaust-gas recirculation (LP-EGR) or high-pressure exhaust-gas recirculation (HP-EGR). In a low-pressure exhaust-gas recirculation system, the exhaust gas is tapped downstream of the turbocharger, i.e. downstream of the turbine, and fed upstream of the compressor to the fresh-air line. As a result of the slight pressure gradient after the turbine, conventional systems use an exhaust-gas flap to effectuate a back pressure so that the pressure differential results in the necessary exhaust gas recirculation rate to the fresh-air line.

To date, exhaust gases are backed up by means of an exhaust gas flap to buildup a respective counterpressure (back pressure) by which the exhaust gas volume is pressed for the necessary exhaust gas recirculation rate into the fresh-air line. The internal combustion engine has to work against this back pressure, causing reduced engine power. In order to still provide the wanted output, the internal combustion engine has to consume more fuel. As a result, fuel consumption and emission of carbon dioxide are increased. In addition, operating-point-dependent counterpressures are experienced as a result of changing flap settings which must be stored in a motor control by respective characteristic lines so that the internal combustion engine or at least its electronic motor system has to be suited to the EGR system.

It would therefore be desirable and advantageous to provide an improved method of operating an internal combustion engine to obviate prior art shortcomings and to reduce fuel consumption.

### SUMMARY OF THE INVENTION

According to one aspect of the present invention, a method of operating an internal combustion engine includes the steps of feeding an exhaust gas flow from an exhaust gas recirculation line of an exhaust gas recirculation system to a fresh-air line, dividing the exhaust gas flow by a gas flow divider during flow from the exhaust gas recirculation line to the fresh-air line through actuation of a control element such that a first flow portion flows back to the exhaust gas recirculation line and a second flow portion flows to an exhaust-gas line, and operating the exhaust gas recirculation system with the gas flow divider substantially in the absence of a back pressure.

The present invention resolves prior art problems by operating the exhaust gas recirculation system with the gas flow substantially in the absence of a back pressure. In other words, the presence of the gas flow divider does not increase the back pressure.

The term “absence of a back pressure” is hereby not to be understood that the pressure of the exhaust gas flow drops to the atmospheric pressure. Exhaust gas conducting systems always experience losses as a result of pipe friction but also throttle losses as a result of pipe tapers, constrictions, or structures for flow dynamics. Also filters, converters, mufflers, elbows, bends, and any obstacle in the flow path of the exhaust gas can cause a pressure drop or generation of back pressure. An issue of the present invention is not the elimination of back pressure generating structures, which is virtually impossible, but rather to operate and configure the gas flow divider of the EGR system in such a way that the exhaust gas recirculation system does not substantially add additional back pressure. The term “back pressure” is also referred to in the field as “built-up counterpressure”. It is the goal of the present invention to minimize this counterpressure in the area of the gas flow divider.

Thus, an exhaust gas recirculation system has been found which does not require the internal combustion engine to work against added exhaust gas back pressure as the exhaust gas volume is controlled and divided, with the exhaust gas pressure being kept constant.

An exhaust gas recirculation system according to the present invention is applicable in particular for non-charged internal combustion engines. Still, the internal combustion engine may include at least one turbocharger having a compressor in the fresh-air line and a turbine in the exhaust-gas line. Advantageously, the exhaust gas recirculation system may be configured as a low-pressure system, tapping exhaust gases from the exhaust-gas line downstream of the turbine and feeding the tapped exhaust gases to the fresh-air line upstream of the compressor. Of course, internal combustion engines charged by pressure-wave superchargers may be constructed accordingly.

Suitably, a pressure sensor is arranged in the exhaust-gas line upstream of the gas flow divider and downstream of the turbine. The pressure sensor ascertains the actual exhaust gas pressure in the exhaust-gas line and downstream of the turbine, respectively. When the pressure detects an exhaust gas pressure which deviates from a predefined desired value, the at least one control element is activated and removed from its neutral position to maintain the exhaust gas pressure at a constant level and to reestablish the desired pressure value. Advantageously, the desired pressure value is selected to correspond to an exhaust gas pressure in an exhaust-gas line from which no exhaust gas is returned to the fresh-air line.

According to another feature of the present invention, air flow sensors in the fresh-air line may be arranged to enable a determination of an exact mixing ratio of fresh air and exhaust gases and thus a precise exhaust gas recirculation rate. The air flow sensors may be arranged in such a way that a first air flow sensor is arranged upstream of the junction of the exhaust gas recirculation line to the fresh-air line to capture a fresh air volume flowing through an optionally arranged throttle flap. A second air flow sensor may be arranged in the exhaust gas recirculation line, advantageously near a junction of the exhaust gas recirculation line to the fresh-air line. In this configuration, the first air flow sensor detects directly the aspirated air volume, whereas the second air flow sensor detects the recirculated exhaust gas volume. It may, however, also be conceivable, to arrange the first air flow sensor downstream of the junction of the exhaust gas recirculation line to the fresh-air line so that the first air flow sensor is then able to ascertain the total volume flow (fresh air volume plus recirculated exhaust gases). As a result, the current EGR rate can be fully determined.

According to another advantageous feature of the present invention, the exhaust gas pressure may be detected by the pressure sensor, wherein advantageously the air flow sensors generate control signals for operating the control element. In order to be able to reach the necessary recirculation rate (recirculated exhaust gas volume) in accordance with the specifications of the motor management, the fresh air volume may be reduced for example by the arrangement of an additional throttle flap in the fresh-air line. In this way, the control dynamics can be enhanced. Operation of the throttle flap is however not necessarily required. As the recirculation rate is dependent on the crankshaft speed and the torque, adjustment of at least one control element can be controlled also by an appropriate functional combination of both signals so that the need for sensors can be eliminated.

Instead of sensors, the application of respective maps or a mathematical model including observer may thus be implemented as signal generator for the at least one control element.

Advantageously, exhaust gases from the exhaust-gas line can flow to the gas flow divider, suitably via the pressure sensor. Branching off from the gas flow divider is the exhaust gas recirculation line, on one hand, and the continuing section of the exhaust-gas line, on the other hand. At least one control element is arranged in the gas flow divider. Advantageously, the gas flow divider has branches to the exhaust gas recirculation line and to the continuing section of the exhaust-gas line, with the branches being defined by a total cross sectional area which advantageously may correspond at least to the clear diameter of the exhaust-gas line.

The control element may advantageously be configured in the form of a flap which has a neutral position in which the control element is positioned in perpendicular relationship to the incoming exhaust gases. The control element may also be realized in the form of a gate or ball valve to name a few examples. The control element moves at precisely the moment when the exhaust gas recirculation rate deviates from the desired value of the motor control, under the condition to advantageously maintain a constant back pressure.

As an alternative, it may be provided to realize the gas flow divider with two control elements, with one control element arranged in the exhaust gas recirculation line and another control element arranged in the exhaust-gas line downstream of the branch of the exhaust gas recirculation line from the exhaust-gas line. Both control elements have a suitable total opening degree which corresponds at least to the clear diameter of the exhaust-gas line in order to prevent a build up of back pressure. Of course, the control element of this alternative configuration can be activated accordingly and may be arranged in an enclosed system.

In summary, the following aspects of the invention are considered especially beneficial:
The exhaust gas recirculation system can be configured in the form of a low pressure system;
The exhaust gas pressure can be determined by at least one pressure sensor and through actuation of control elements maintained at a value in correspondence with a value without exhaust gas recirculation system;
Air flow sensors can be used in the fresh-air line and the exhaust gas recirculation line to control or regulate the exhaust gas pressure and to measure the aspirated and recirculated gas volumes;
The exhaust gas pressure can be adjusted through actuation of a control element, wherein a single control element can be arranged in the gas flow divider, or, as an alternative, two control elements, operating independently from one another, may be provided, with one control element arranged in the exhaust gas recirculation line and the other control element arranged downstream of the exhaust gas recirculation line in a branch off the exhaust gas recirculation line;
The gas flow divider has branches to the exhaust gas recirculation line and the continuing section of the exhaust-gas line, with the branches jointly defining a total cross sectional area which corresponds at least to the clear diameter of the exhaust-gas line.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a basic schematic illustration of an internal combustion engine with gas flow divider and upstream pressure sensor;

FIG. 2 is a schematic illustration of an internal combustion engine with a map control of a control element; and

FIG. 3 is a schematic illustration of an internal combustion engine with modified gas flow divider.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

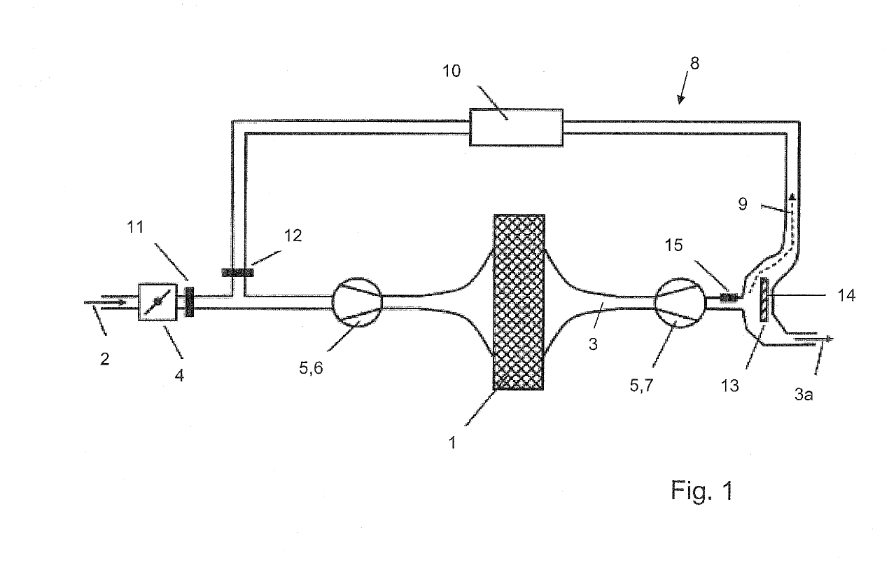

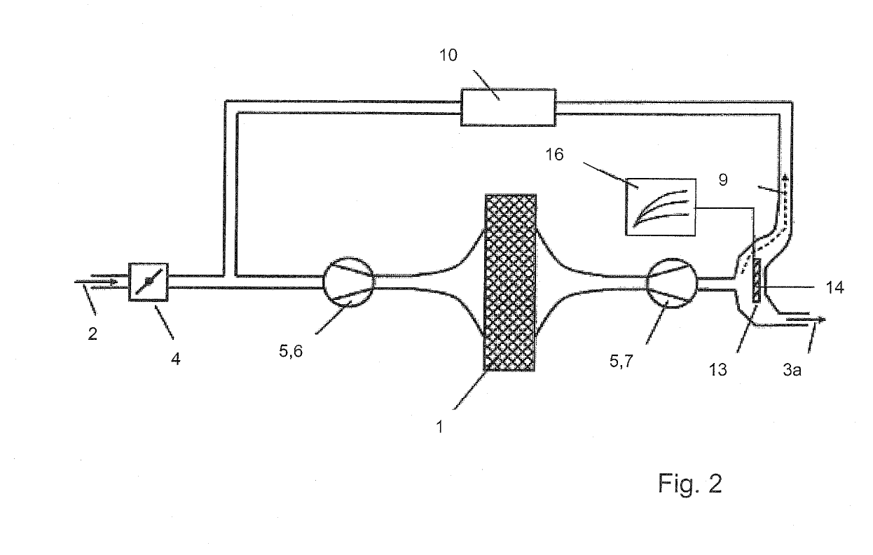

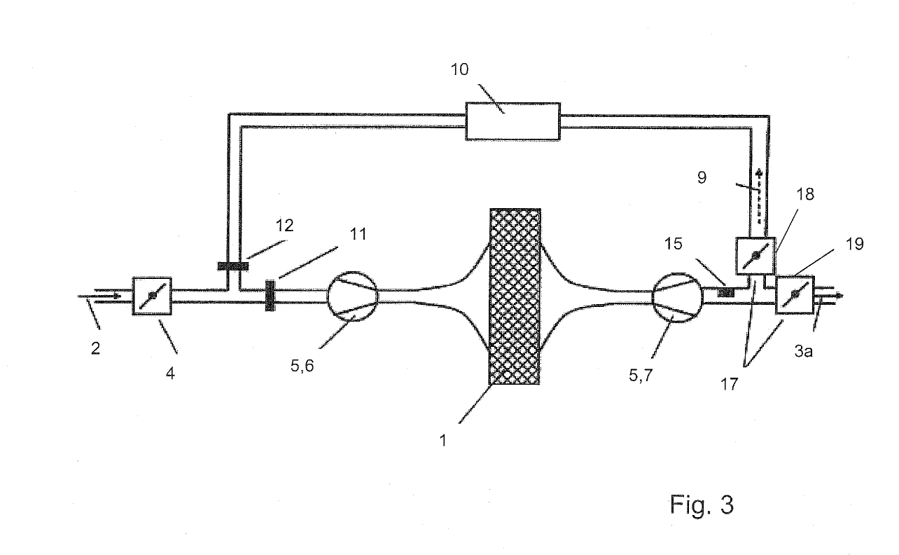

Turning now to the drawing, and in particular to FIG. 1, there is shown a basic schematic illustration of an internal combustion engine 1 having a fresh-air line 2 and an exhaust-gas line 3. A throttle valve 4 is disposed in the fresh-air line 2. The internal combustion engine 1 further includes a turbocharger 5 having a compressor 6 disposed in the fresh-air line 2 and a turbine 7 disposed in the exhaust-gas line 3. Further provided is an exhaust gas recirculation system (EGR) 8 by which exhaust gas of the internal combustion engine 1 in the exhaust-gas line 3 is branched off into an exhaust gas recirculation line 9 and fed to the fresh-air line 2. Various components, such as heat exchanger, EGR bypass, wastegate, or condensate separator can be disposed in the exhaust gas recirculation line 9. For sake of simplicity, these components are indicated in FIG. 1 as well as in FIGS. 2 and 3 by a box 10.

In the non-limiting example of FIG. 1, the exhaust gas recirculation line 9 diverts downstream of the turbine 7 exhaust gas from the exhaust-gas line 3 and feeds it back to the fresh-air line 2 upstream of the compressor 6. Thus, the exhaust gas recirculation system 8 is a low-pressure exhaust gas recirculation system.

Disposed downstream of the throttle valve 4 in the fresh-air line 2 is a first air flow sensor 11 to ascertain a fresh air volume flow. A second air flow sensor 12 is disposed in the exhaust gas recirculation line 9 in proximity of or, as viewed in flow direction of the exhaust gas, at least upstream of the junction of the exhaust gas recirculation line 9 to the fresh-air line 2 and downstream of the components 10. The second air flow sensor 12 detects a recirculated exhaust gas volume flow.

The exhaust-gas line 3 feeds to a gas flow divider 13 by which an incoming exhaust gas volume flow is divided into a first flow portion deflected into the exhaust gas recirculation line 9 and a second flow portion deflected into a continuing section 3a of the exhaust-gas line 3, without encountering an additional exhaust gas counterpressure or back pressure which would require the internal combustion engine to work against.

In the non-limiting example of FIG. 1, the gas flow divider 13 is configured in the form of a T-shaped head land and includes a control element 14. In FIG. 1, the control element 14 assumes a neutral position in which a defined recirculation rate is established. The control element 14 may be configured as a flap, gate, or ball valve, to name a few examples. Each of the exhaust gas recirculation line 9 and the continuing exhaust-gas section 3a branches off the gas flow divider 13. Both these branches are defined by a total cross sectional area which corresponds preferably at least to the clear diameter of the exhaust-gas line 3. As a result, there is no buildup of additional back pressure, while exhaust gas volumes flowing into the respective branches are divided in correspondence to the ratio of the openings. Of course, the geometric configuration of the gas flow divider can be best suited to the situation at hand so that the illustrated configuration is to be understood as an example only.

An exact mixing ratio and thus a precise exhaust gas recirculation rate can be realized through the use of the air flow sensors 11, 12. Disposed downstream of the turbine 7 is a pressure sensor 15 to ascertain an actual exhaust gas pressure in the exhaust-gas line 3. The exhaust gas pressure should suitably be maintained at a desired pressure value which corresponds to an exhaust gas pressure of an internal combustion engine without (low pressure) exhaust gas recirculation system. In the event the actual exhaust gas pressure deviates from the desired pressure value, the control element 14 is actuated such that the incoming flow portions into both branches are suitably divided. Currently preferred is the use of signals from the air flow sensors 11, 12 as control variables for the control of the control element 14. In order to be able to aspirate the recirculated flow portion volume in accordance with dynamic specifications of the motor management, the fresh air volume can be reduced through proper actuation of the throttle valve 4. As the recirculated exhaust gas volume (exhaust gas recirculation rate) is dependent on the rotational speed of the crankshaft and the torque, the adjustment of the control element can be easily controlled by a functional combination of the signals of the air flow sensors 11, 12.

Referring now to FIG. 2, there is shown another exemplified embodiment of the present invention. Parts corresponding with those in FIG. 1 are denoted by identical reference numerals and not explained again. The description below will center on the differences between the embodiments. In this embodiment, provision is made for maps or a mathematical model including observer for the control element 14 instead of the sensors 11, 12, 15. For sake of simplicity, FIG. 2 depicts a block 16 which accommodates respective programs and required electronic components. Otherwise, the exemplified embodiment of FIG. 2 corresponds to the exemplified embodiment of FIG. 1.

FIG. 3 shows a yet another exemplified embodiment of the present invention. Parts corresponding with those in FIG. 1 are denoted by identical reference numerals and not explained again. The description below will center on the differences between the embodiments. In this embodiment, provision is made for an air flow sensor 11 which is arranged in the fresh-air line 2 downstream of the junction of the exhaust gas recirculation line 9 to the fresh-air line 2. The air flow sensor 11 ascertains in the fresh-air line 2 a total volume flow which is comprised of the fresh air volume and the recirculated exhaust gas volume. This may, of course, also be provided in the embodiment of FIG. 1.

In the embodiment of FIG. 3, provision is also made for a modified gas flow divider 17 which includes a control element 18 in the exhaust gas recirculation line 9 and a control element 19 in the continuing section 3a of the exhaust-gas line 3. The opening degrees of both control elements 18, 19 are defined by a total cross sectional area which preferably corresponds at least to the clear diameter of the exhaust-gas line 3 so that the gas flow divider 17 has also a total cross sectional area which corresponds at least to the clear diameter of the exhaust-gas line 3. The control elements 18, 19 can be activated accordingly and can be arranged preferably in an enclosed system.

In accordance with the present invention, an exhaust gas recirculation system can be implemented in the absence of a back pressure so that the internal combustion engine is not adversely affected by operating-point-dependent counterpressures or does not consume more fuel at same performance so that emission of carbon dioxide can be reduced compared to an exhaust gas recirculation system which requires generation of an exhaust gas counterpressure to maintain the exhaust gas recirculation rate. An exhaust gas recirculation system according to the present invention does not require an exhaust gas counterpressure because the exhaust gas volume flow is divided at constant exhaust gas pressure.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method of operating an internal combustion engine, comprising the steps of:
feeding an exhaust gas flow from an exhaust gas recirculation line of an exhaust gas recirculation system to a fresh-air line;
dividing the exhaust gas flow by a gas flow divider during flow from the exhaust gas recirculation line to the fresh-air line through actuation of a control element such that a first flow portion flows back to the exhaust gas recirculation line and a second flow portion flows to a continuing section of an exhaust-gas line; and
operating the exhaust gas recirculation system with the gas flow divider substantially in the absence of a back pressure.

2. The method of claim 1, wherein the exhaust gas recirculation system is configured in the form of a low-pressure system.

3. The method of claim 1, further comprising the steps of determining an exhaust gas pressure by a pressure sensor, and maintaining the exhaust gas pressure through actuation of the control element substantially at a value which corresponds to a value without exhaust gas recirculation system.

4. The method of claim 3, further comprising the step of controlling the exhaust gas pressure by air flow sensors in the fresh-air line and the exhaust gas recirculation line, with the air flow sensors measuring a gas rate in the first flow portion and a gas rate in an aspirated fresh air volume.

5. The method of claim 4, further comprising the step of reducing the aspirated fresh air volume through control of a throttle valve to thereby implement a mixture of the aspirated fresh air volume with a particular exhaust gas volume of the recirculated first flow portion at a predefined ratio.

6. The method of claim 1, further comprising the steps of adjusting an exhaust gas pressure through actuation of the control element in the gas flow divider.

7. The method of claim 1, further comprising the steps of adjusting an exhaust gas pressure through independent actuation of two control elements, with one of the control elements being arranged in the exhaust gas recirculation line and the other one of the control elements being arranged downstream of the exhaust gas recirculation line in a branch off the exhaust gas recirculation line.
